(19) United States
(12) Patent Application Publication
(10) Pub. No.: US 2015/0179054 A1
(43) Pub. Date: Jun. 25, 2015

(54) MOBILE DEVICE INTERFACE FOR COMMERCIAL RTU

(71) Applicant: Lennox Industries Inc., Richardson, TX (US)

(72) Inventors: Daniel Castillo, Richardson, TX (US); John Manby, McKinney, TX (US); Farhad Abrishamkar, Arlington, TX (US)

(73) Assignee: Lennox Industries Inc., Richardson, TX (US)

(21) Appl. No.: 14/137,719

(22) Filed: Dec. 20, 2013

(51) Int. Cl. G08C 17/02

(52) U.S. Cl. CPC G08C 17/02; G08C 2201/30; G08C 2201/93

(57) ABSTRACT

In an embodiment, a mobile device for operating a HVAC unit is provided. The mobile device is configured to provide a graphical user interface to the HVAC unit. The mobile device is further configured to receive user input for performing a function of the HVAC unit and to instruct the HVAC unit to perform the function.

### TECHNICAL FIELD

This application relates to HVAC rooftop units (RTUs) and, more particularly, to user interfaces for commercial HVAC RTUs.

### BACKGROUND

Newer commercial Heating, Ventilation, and Air Conditioning (HVAC) RTUs are complex. These RTUs offer customers greater customization and features, are easier to use, troubleshoot, and install, and in some cases are needed to comply with regulatory requirements. To offer these additional capabilities, the RTUs often utilize modern microprocessors.

However, the user interfaces for commercial RTUs remain relatively primitive. Commercial HVAC RTUs are controlled, configured, serviced, and troubleshot through these primitive user interfaces. For example, a user interface may offer only a low-resolution text display that can show only a single, short line of text at a time. A user may be expected to use such a display to navigate through menus of the many features offered by the RTU. In contrast to their advanced capabilities, existing RTU user interfaces are difficult to use and often result in user frustration.

Considerations peculiar to commercial HVAC RTUs have limited development of more advanced user interfaces. First, the RTUs, and consequently their user interfaces, are located outdoors. Many solutions are unsuited for the outdoor environments. Second, existing RTU user interfaces are so primitive that the hardware components for a modern user interface, such as a large screen, would be a significant increase in the cost of the RTU. Third, typical RTUs need user interaction only sporadically after installation. The advanced user interface would only be used for a brief part of the lifetime of the RTU.

One attempt to provide an alternate user interface was a laptop computer connecting to a RTU through the laptop's serial port. Through specialized software, laptops could read data from and write data to a RTU. However, the laptops were effectively just a conduit to display and edit RTU data. In contrast, traditional RTU user interfaces permitted a user to navigate through a hierarchy of menus and work with one feature at a time. The laptops, while alternatives to traditional on-board user interfaces attached to the RTUs, did not provide a modern user interface by today's standards.

Furthermore, the technicians required specialized training to use the laptops, the laptops required maintenance, the software had to be kept up to date, and the laptops added weight for the technician to carry. Sending a technician with a laptop historically cost much more per hour than a technician without a laptop. Laptops did not replace traditional RTU user interfaces.

It would be desirable if a RTU could offer a modern, user-friendly user interface without significant changes to the hardware of the RTU. Such a user interface could reduce the time a technician spends interacting with a RTU, which in turn could increase the technician's productivity at installation, service, and troubleshooting.

### SUMMARY

In an embodiment, a mobile device for operating a HVAC unit is provided. The mobile device is configured to provide a graphical user interface to the HVAC unit. The mobile device is further configured to receive user input for performing a function of the HVAC unit and to instruct the HVAC unit to perform the function.

### DESCRIPTION OF DRAWINGS

For a more complete understanding of the present invention and the advantages thereof, reference is now made to the following Detailed Description taken in conjunction with the accompanying drawings, in which:

FIG. 1A depicts components of a HVAC unit which may operate in accordance with an exemplary embodiment of the present invention;

FIG. 1B depicts components of a mobile device which may operate in accordance with an exemplary embodiment of the present invention;

FIG. 2 depicts a HVAC control system in accordance with an exemplary embodiment of the present invention;

FIG. 3 depicts a wireless HVAC control system in accordance with an exemplary embodiment of the present invention;

FIG. 4 depicts a HVAC control system with network connection functionality in accordance with an exemplary embodiment of the present invention; and

FIG. 5 depicts a HVAC control system 400 with direct network connection functionality in accordance with an exemplary embodiment of the present invention.

### DETAILED DESCRIPTION

In the following discussion, numerous specific details are set forth to provide a thorough explanation. However, such specific details are not essential. In other instances, well-known elements have been illustrated in schematic or block diagram form. Additionally, for the most part, specific details within the understanding of persons of ordinary skill in the relevant art have been omitted.

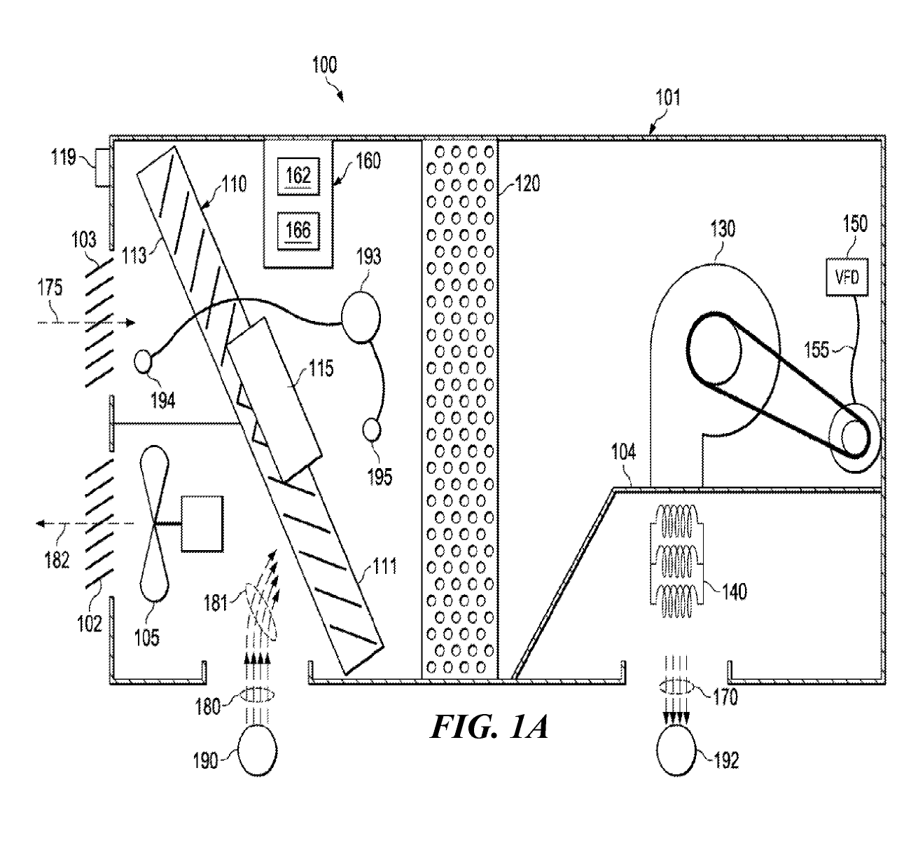

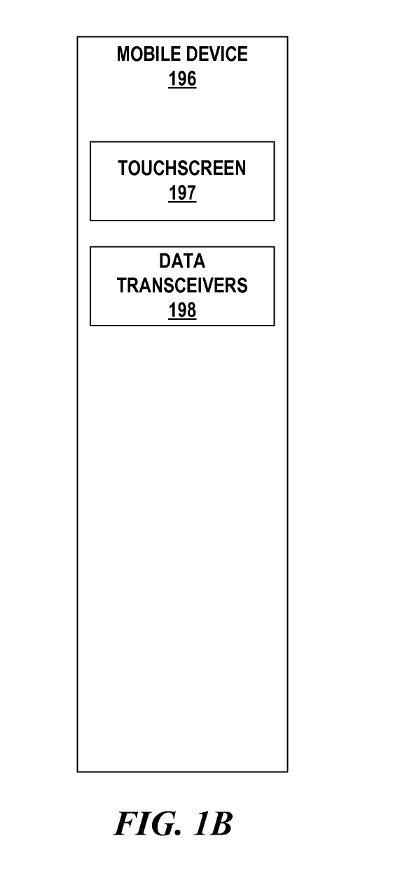

Referring to FIG. 1A, depicted is a block diagram of an exemplary HVAC unit 100 which may operate in accordance with an exemplary embodiment of the present invention. HVAC unit 100 includes enclosure 101 (e.g., a cabinet) with openings for exhaust air, ventilation air, return air and supply air. Enclosure 101 includes exhaust vents 102 and ventilation vents 103 at the corresponding exhaust air and ventilation air openings. Within enclosure 101, unit 100 includes exhaust fan 105, economizer 110, cooling element 120, indoor fan or blower 130, and heating element 140. Unit 100 also includes a compressor (not illustrated).

Additionally, unit 100 includes fan controller 150 and HVAC controller 160. Fan controller 150 is coupled to blower 130 via cable 155. Cable 155 is a conventional cable used with HVAC systems. HVAC controller 160 can be connected (not illustrated) to various components of unit 100, including thermostat 119 for determining outside air temperature, via wireless or hardwired connections for communicating data. Conventional cabling or wireless communications systems may be employed. Also included within enclosure 101 is partition 104 that supports blower 130 and provides a separate heating section.

Unit 100 is an RTU (roof top unit). One skilled in the art will understand that unit 100 can include other partitions or components that are typically included within an HVAC system such as an RTU. While the embodiment of unit 100 is discussed in the context of a RTU, the scope of the disclosure includes other HVAC applications that are not roof-top mounted.

Blower 130 operates to force air stream 170 into a structure, such as a building, being conditioned via an unreferenced supply duct. Return airstream 180 from the building enters the system 100 at an unreferenced return duct.

First portion 181 of air stream 180 re-circulates through economizer 110 and joins air stream 170 to provide supply air to the building. A second portion of air stream 180 is air stream 182 that is removed from unit 100 via exhaust fan 105.

Economizer 110 operates to vent a portion of return air 180 and replace the vented portion with air stream 175. Thus air quality characteristics such as CO2 concentration and humidity may be maintained within defined limits within the building being conditioned. Economizer 110 includes indoor damper 111, outdoor damper 113 and actuator 115. Actuator 115 drives (opens and closes) indoor and outdoor dampers 111 and 113 (i.e., the blades of the indoor and outdoor dampers 111 and 113). Though economizer 110 includes two damper assemblies, one skilled in the art will understand that the concepts of the disclosure also apply to those economizers or devices having just a single damper assembly, an outdoor damper assembly.

HVAC controller 160 includes interface 162 and firmware 166. Firmware 166 may be implemented on a processor and/or a memory of HVAC controller 160. Firmware 166 may direct the operation of or at least part of the operation of HVAC unit 100. Firmware 166 may generate control signals that are transmitted that are transmitted to the various components of HVAC unit 100 to direct the operation of those components. Firmware 166 may generate the control signals in response to feedback data that is received from the various sensors and/or components of HVAC unit 100.

HVAC controller 160 may have a USB port which connects to a USB device for HVAC unit 100 to communicate with. The USB port may receive a USB storage device containing a firmware update for firmware 166.

Interface 162 receives feedback data from sensors and components of HVAC unit 100 and transmits control signals thereto. As such, HVAC controller 160 may receive feedback data from, for example, exhaust fan 105, blower 130 and/or fan controller 150, economizer 110 and thermostat 119, and transmit control signals thereto if applicable. One skilled in the art will understand that the location of HVAC controller 160 can vary with respect to HVAC unit 100.

Interface 162 may be a conventional interface that employs a known protocol for communicating (i.e., transmitting and receiving) data. Interface 162 may be configured to receive both analog and digital data. The data may be received over wired, wireless or both types of communication mediums. In some embodiments, a communications bus may be employed to couple at least some of the various operating units to interface 162. Though not illustrated, interface 162 includes input terminals for receiving feedback data.

The feedback data received by interface 162 includes data that corresponds to a pressure drop across outdoor damper 113 and damper position of economizer 110. In some embodiments, the feedback data also includes the supply airflow rate. Various sensors of unit 100 are used to provide this feedback data to HVAC controller 160 via interface 162. In some embodiments, return pressure sensor 190 is positioned in the return air opening to provide a return static pressure. Return pressure sensor 190 measures the static pressure difference between the return duct and air outside of HVAC unit 100. In one embodiment, supply pressure sensor 192 is also provided in the supply air opening to indicate a supply pressure to HVAC controller 160. Supply pressure sensor 192 measures the static pressure difference between the return duct and the supply duct. Pressure sensor 193 is used to provide the pressure drop across outdoor damper 113 of the economizer 110. Pressure sensor 193 is a conventional pressure transducer that determines the static pressure difference across outdoor damper 113. Pressure sensor 193 includes first input 194 and second input 195 for receiving the pressure on each side of outdoor damper 113. The pressure sensors discussed herein can be conventional pressure sensors typically used in HVAC systems.

Referring to FIG. 1B, depicted is a block diagram of an exemplary mobile device 196 which may operate in accordance with an exemplary embodiment of the present invention. Mobile devices, typically consumer-grade smartphones and tablets, are becoming commonly carried by HVAC technicians. Mobile device 196 may include touchscreen 197 and is capable of running applications offering a modern user interface. Mobile device 196 may also include one or more data transceivers 198. Data transceivers 198 may permit mobile device 196 to wirelessly access to the Internet using a cellular network (e.g. 3G or 4G) or wireless local area network (e.g. IEEE 802.11 or Wi-Fi).

By temporarily incorporating mobile device 196 to present a user interface, HVAC unit 100 can overcome many of the problems that have thus far hindered HVAC user interfaces. First, because mobile device 196 only needs to be present when a technician is, touchscreen 197 does not need to withstand an outdoor environment long-term. Second, because many HVAC technicians already own and carry mobile devices and RTUs already utilize modern microprocessors, the additional cost of providing the user interface is limited. Third, because the user interface is carried by the technician rather than attached to HVAC unit 100, the usage of the user interface will match the workload of the technician rather than the needs of any one RTU.

Mobile devices also typically come with features useful for an application providing a HVAC interface. Mobile devices typically come with functionality for keeping applications up to date. Thus, an application on mobile device 196 for interacting with an RTU can easily always be kept up to date. Mobile devices commonly have Internet connections, such as those provided by data transceivers 198. An Internet connection of mobile device 196 may be used to send data from the Internet to HVAC unit 100 and vice versa. Mobile device user interfaces are now commonplace, so many technicians may already be familiar with the application's user interface.

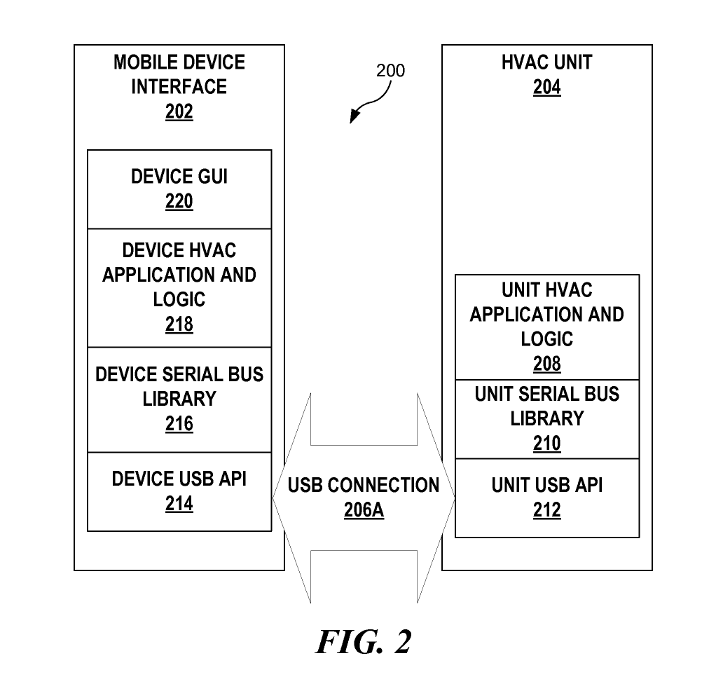

With reference to FIG. 2, depicted is a HVAC control system 200 in accordance with an exemplary embodiment of the present invention. Control system 200 includes mobile device interface 202 and HVAC unit 204. Mobile device interface 202 and HVAC unit 204 may communicate through Universal Serial Bus (USB) connection 206A. Mobile device interface 202 may be a mobile device, such mobile device 100, running an application that enables the mobile device to communicate with HVAC unit 204. Mobile device interface 202 may be a smartphone or tablet. Mobile device interface 202 may be a technician's personal device or one provided to the technician for the technician's work.

The HVAC unit 204 may have the same hardware components as HVAC unit 100 or another conventional HVAC RTU, except that its HVAC controller processor may run unit HVAC application and logic 208 to enable it to interact with mobile device interface 202.

Conventional HVAC RTUs receive firmware updates from USB storage devices through USB connections. HVAC unit 204 may utilize unit serial bus library 210 and unit USB Application Programming Interface (API) 212, conventionally for installing these updates, to communicate over USB connection 206A. Unit HVAC application and logic 208, unit serial bus library 210, and unit USB API 212 may all be part of the firmware of the HVAC controller of HVAC unit 100.

Mobile devices are likewise also commonly able to communicate over USB connections like USB connection 206A. Mobile device interface 202 may utilize device USB API 214 and device serial bus library 216 to communicate over USB connection 206A. Unit serial bus library 210 and device serial bus library 216 may be specialized serial bus libraries for communications to and from a HVAC unit. Unit serial bus library 210 and device serial bus library 216 may follow a protocol specifically designed for such communications.

Mobile device interface 202 may have a processor running device HVAC application and logic 218 to enable mobile device interface 202 to communicate with HVAC unit 204. Device HVAC application and logic 218 may provide device Graphical User Interface (GUI) 220. GUI 220 is a user interface to HVAC unit 204.

Through device GUI 220, a user may operate the functions of HVAC unit 204. Mobile device interface 202 may receive user input for performing a function of HVAC unit 204. Mobile device interface 202 may then instruct HVAC unit 204 to perform the function.

In particular, device GUI 220 may be an interface for the user to perform the functions of displaying and changing variables. These variables may include operational parameters and the heating/cooling deadband (the band of temperatures where HVAC unit 204 does not heat or cool). The variables may include parameters for HVAC unit 204's compressor, blower, economizer, and fan, such as on and off delays and safety limits or thresholds for alerts. The variables may include whether specific features of HVAC unit 204 are enabled or disabled. The variables may include minimum and maximum airflow values, blower speeds, and control algorithm parameters. Other variables are possible.

Additional functions device GUI 220 may be an interface for performing include initial commissioning of HVAC unit 204 and configuring network communications for HVAC unit 204. Other functions are possible.

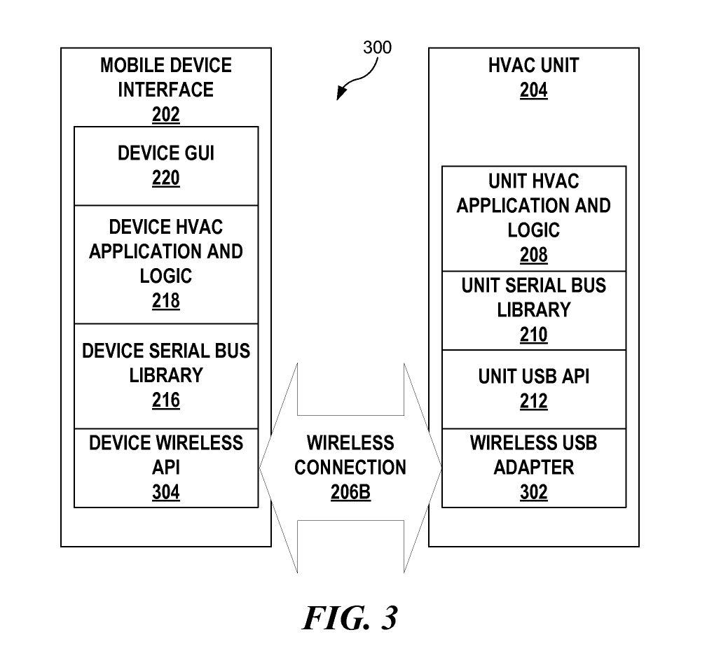

With reference to FIG. 3, depicted is a wireless HVAC control system 300 in accordance with an exemplary embodiment of the present invention. Wireless HVAC control system 300 differs from the preceding control system in that wireless connection 206B has been substituted for the USB connection. Wireless connection 206B is preferably a Bluetooth connection, but other wireless connections may be used.

Unlike USB, HVAC units are not commonly capable of wireless communications. Thus, HVAC unit 204 may be provided with wireless USB adapter 302 to enable wireless communications through unit USB API 212. Mobile devices are commonly capable of wireless communications. Device wireless API 304 may be substituted for the device USB API of the USB control system.

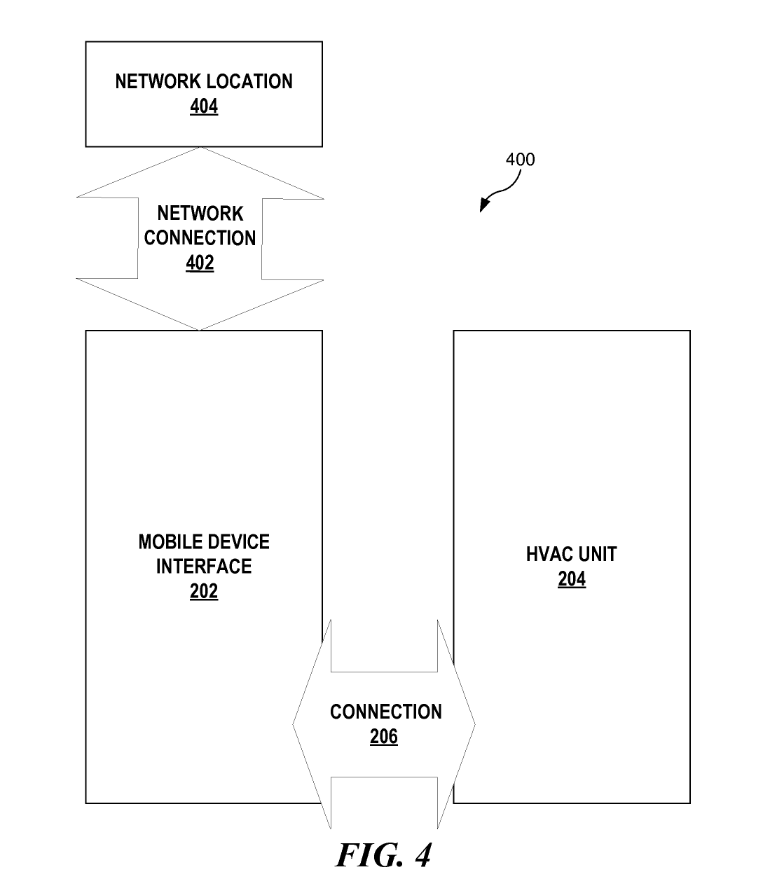

With reference to FIG. 4, depicted is a HVAC control system 400 with network connection functionality. Mobile device interface 202 and HVAC unit 204 may communicate through connection 206 as in connection 206A in FIG. 2 or connection 206B in FIG. 3. In addition to a modern GUI for HVAC unit 204, mobile device interface 202 may provide HVAC unit 204 with network connection 402. Network connection 402 may be a cellular Internet connection.

Mobile device interface 202 may receive data from HVAC unit 204 over connection 206 and send the data to network location 404 over network connection 402. Mobile device interface 202 may also receive data from network location 404 over network connection 402 and send the data to HVAC unit 204 over connection 206.

Network location 404 may be a service platform online gateway, such as a website, for servicing HVAC RTUs. Network location 404 may offer an online interface to HVAC unit 204. A remote user may use network location 404 to service HVAC unit 204, such as performing remote diagnostics, remote data analysis, and remote troubleshooting. The remote user may use network location 404 to create remote service verification reports.

A remote user may send firmware updates to the RTU through network connection 402 and connection 206, rather than connecting a USB device to HVAC unit 204. Alternately, a user of mobile device interface 202 may download a firmware update from network location 404 and provide the firmware update to HVAC unit 204 over connection 206. Either way, the firmware update received by HVAC unit 204 can always be the most current version available at network location 404. In contrast, the prior method, sending a technician with a USB storage device to HVAC unit 204, had the potential for the USB storage device to contain an out-of-date firmware update.

Network location 404 may provide customer support and technical support resources to a technician using mobile device interface 202. Mobile device interface 202 may obtain configuration data from HVAC unit 204 and send this configuration data to network location 404. In response, network location 404 may send mobile device interface 202 customer support and technical support resources appropriate for the configuration of HVAC unit 204.

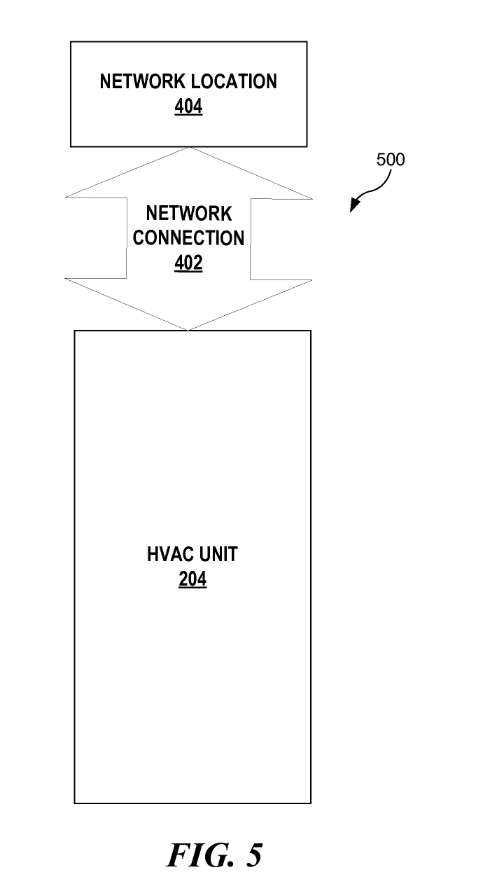

With reference to FIG. 5, depicted is a HVAC control system 500 with direct network connection functionality. As an alternative to system 400, HVAC unit 204 may be provided with network connection 402 directly. For example, HVAC unit 204 may be given a data transceiver like data transceivers 198 in FIG. 1A. The data transceiver may provide HVAC unit 204 with a cellular data connection. Network location 404 may then communicate directly with HVAC unit 204 over network connection 402, without the need for mobile device interface 202. HVAC unit 204 and network location 404 may interact with each other as in HVAC control system 400 in FIG. 4.

In HVAC control systems 200, 300, and 400, the mobile device application of mobile device interface 202 may interface with other applications in the mobile device. For example, the application may interact with an email application in the mobile device to email service reports. The application may interface with a web browser in the mobile device to send HVAC unit 204 configuration data and registration data to a website portal. The application may provide HVAC unit 204 configuration data to another mobile app which offers service quotes and part prices.

An existing HVAC unit may be easily retrofitted to work in HVAC control systems 200, 300, and 400. As previously discussed, a suitable unit serial bus library 210 and unit USB API 212 already exists on many HVAC units for receiving firmware updates. To produce a HVAC unit for HVAC control system 200, an HVAC unit may only need to be given a firmware update containing unit HVAC application and logic 208. To produce a HVAC unit for HVAC control system 300, a unit may additionally need to be given wireless USB adapter 302. An HVAC unit from either HVAC control system 200 or HVAC control system 300 may be suitable for HVAC control system 400.

It is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of various embodiments.

We claim:

1. A mobile device for operating a HVAC unit, the mobile device configured to:
provide a graphical user interface to the HVAC unit;
receive user input for performing a function of the HVAC unit; and
instruct the HVAC unit to perform the function.

2. The mobile device of claim 1, wherein the mobile device comprises a smartphone.

3. The mobile device of claim 1, further configured to communicate with the HVAC unit over a wired connection.

4. The mobile device of claim 1, further configured to communicate with the HVAC unit over a wireless connection.

5. The mobile device of claim 1, wherein the user input comprises touchscreen input.

6. The mobile device of claim 1, wherein the function comprises displaying a variable of the HVAC unit.

7. The mobile device of claim 1, wherein the function comprises changing a variable of the HVAC unit.

8. The mobile device of claim 7, wherein the variable comprises at least a portion of a heating/cooling deadband.

9. The mobile device of claim 7, wherein the variable comprises a parameter for a compressor, blower, economizer, or fan.

10. A method for operating a HVAC unit, the method comprising:
a mobile device providing a graphical user interface to the HVAC unit;
the mobile device receiving user input for performing a function of the HVAC unit; and
the mobile device instructing the HVAC unit to perform the function.

11. The method of claim 10, wherein the mobile device comprises a smartphone.

12. The method of claim 10, wherein the HVAC unit comprises an outdoor commercial rooftop unit.

13. The method of claim 10, further comprising connecting the mobile device to the HVAC unit with a wired connection.

14. The method of claim 10, further comprising wirelessly connecting the mobile device to the HVAC unit.

15. The method of claim 14, further comprising providing a wireless USB adapter to the HVAC unit.

16. The method of claim 10, wherein the user input comprises touchscreen input.

17. The method of claim 10, wherein the function comprises displaying a variable of the HVAC unit.

18. The method of claim 10, wherein the function comprises changing a variable of the HVAC unit.

19. The method of claim 18, wherein the variable comprises at least a portion of a heating/cooling deadband.

20. The method of claim 18, wherein the variable comprises a parameter for a compressor, blower, economizer, or fan.
